(19) United States
(12) Patent Application Publication
(10) Pub. No.: US 2014/0322014 A1
(43) Pub. Date: Oct. 30, 2014

(54) VERTICAL AXIS WIND TURBINE

(71) Applicant: Arthur William George Hetherington, Hemel Hempstead (GB)

(72) Inventor: Arthur William George Hetherington, Hemel Hempstead (GB)

(21) Appl. No.: 14/359,883

(22) PCT Filed: May 25, 2012
(86) PCT No.: PCT/GB2012/000464

§ 371 Date: May 21, 2014

(30) Foreign Application Priority Data
Jan. 23, 2012 (GB) 1201217.5

(51) Int. Cl. F03D 3/06; F03D 3/02

(52) U.S. Cl. CPC F03D 3/067; F03D 3/02
USPC 416/132 B

(57) ABSTRACT

This Vertical Axis Wind Turbine is designed differently to currently viewed Wind Turbines. It comprises of multiple pairs of boom projections spirally twinned around a Turbine Column, essentially they're opposed Helicoids. During favourable winds, arranged lines of equidistantly spaced identical swivelling Vanes mounted within skeletal booms lever a Turbine Column around an Axis Column. Its more positive, dynamically gainful wind design produces significantly higher torque which enables this model to turn six super conductor generators to produce abundantly greater 3 Phase electricity within a smaller footprint, less costly energy that can be fed into a National Grid System.

This mechanism is about a Hi-Torque Vertical Axis Wind Turbine that is driven by a series of face changing Wind Power Booms fixed around a Turbine Column. The design is dedicated toward producing added torque to actuate multiple 3 Phase Generators on demand according to wind capacity. It also operates within a small footprint, making it space efficient and viably operative throughout global wind zones.

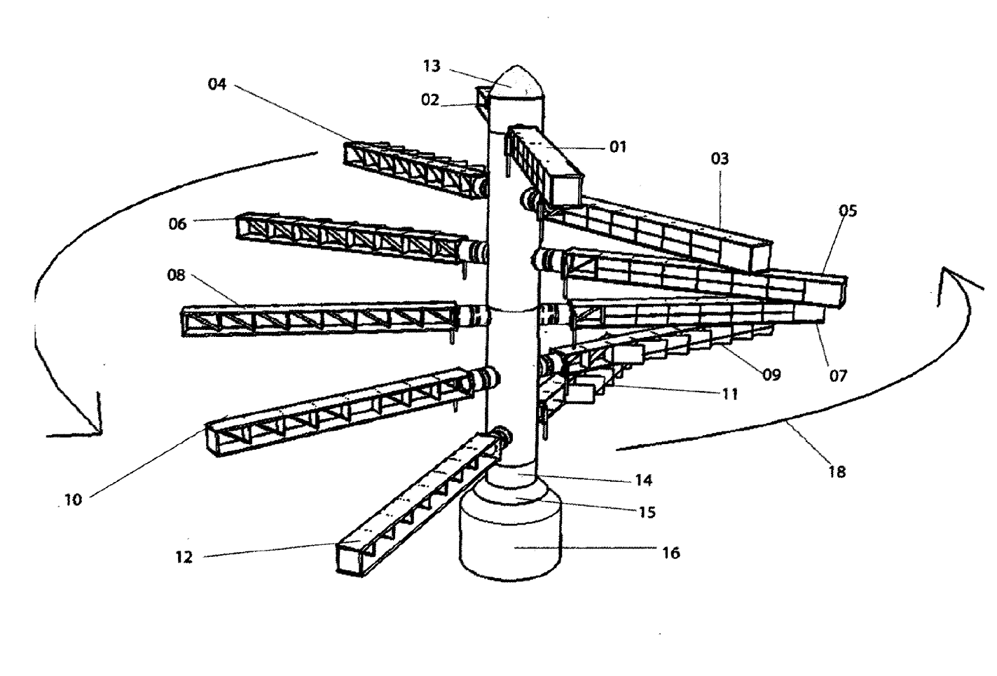

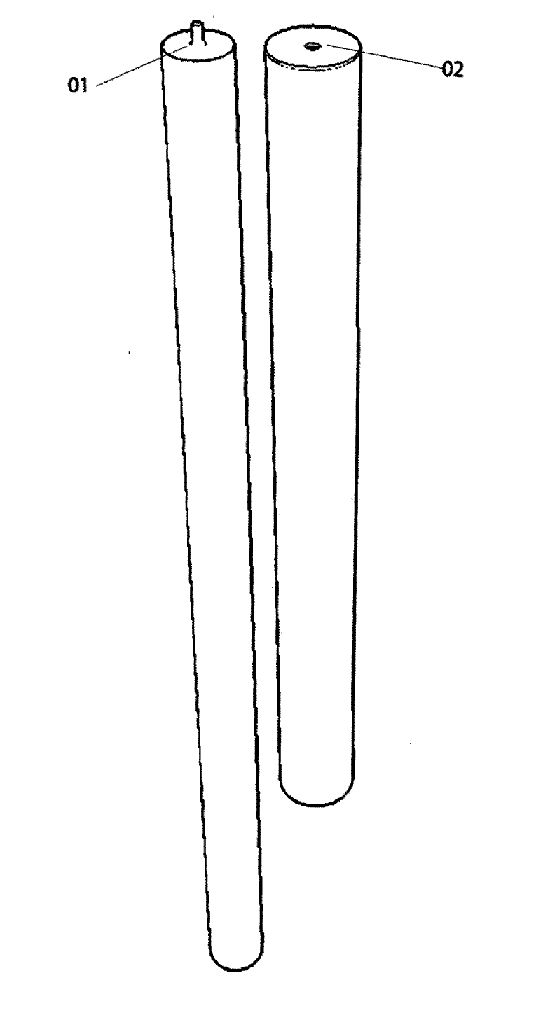

An overall concept of the design is illustrated with FIG. 1/18.

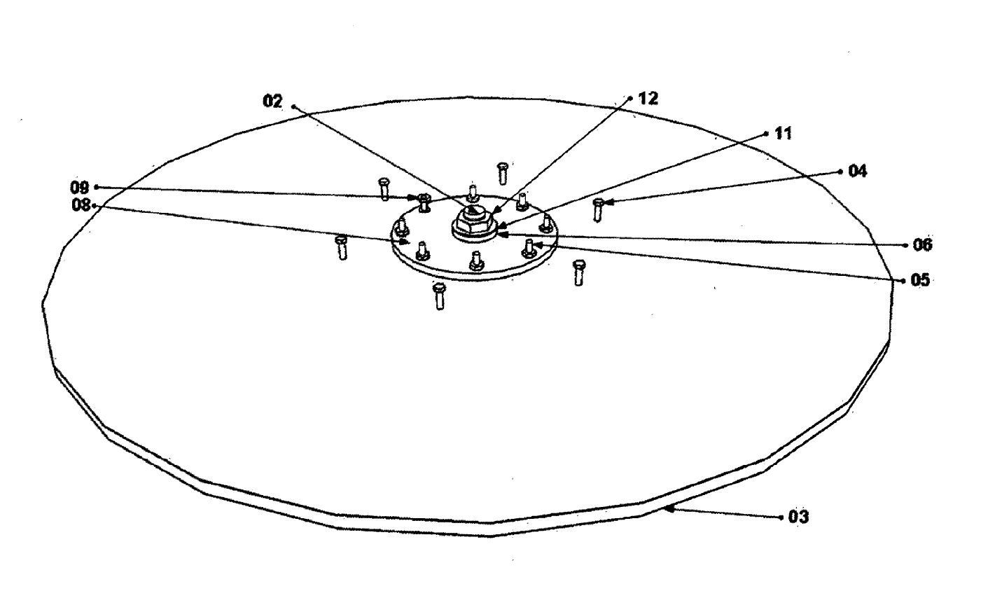

The main structure is supported on a sturdy Pipe or Column that functions as an Axis; and will be referred to as the Axis Column. This Axis Column is fixed into a ground based concrete foundation. A large Stub Axle is pre fixed on the upper end of the Axis Column in the top of its Capping Plate FIG. 2/18—2. The Axis Column is positioned dead vertical in a concrete Based foundation and then a Larger Diameter Pipe called a Turbine Column incorporating a specially female tapered hole or concentric stepped centre hole of plural shaped steps; that can be right angled, tapered, dished or curved steps, or even a straight hole that will act as a Collet Seat that is machined dead centre into the Capping Plate of the Turbine Column's Capping Plate. A matching profile Collet holding the Main Axis Bearing within a hole on the underside of the Collet is placed into the Collet retainer from above. Note that the Axis bearing will be secured in situ with plural screws or Alan Type screws through the Collet sides. In doing so, the Main Axis Bearing is lowered over the Stub Axle fixed in the centre of the axis Column's Capping Plate. Note that the bearing will be secured in situ with plural screws or Alan Type screws through the Collet sides.

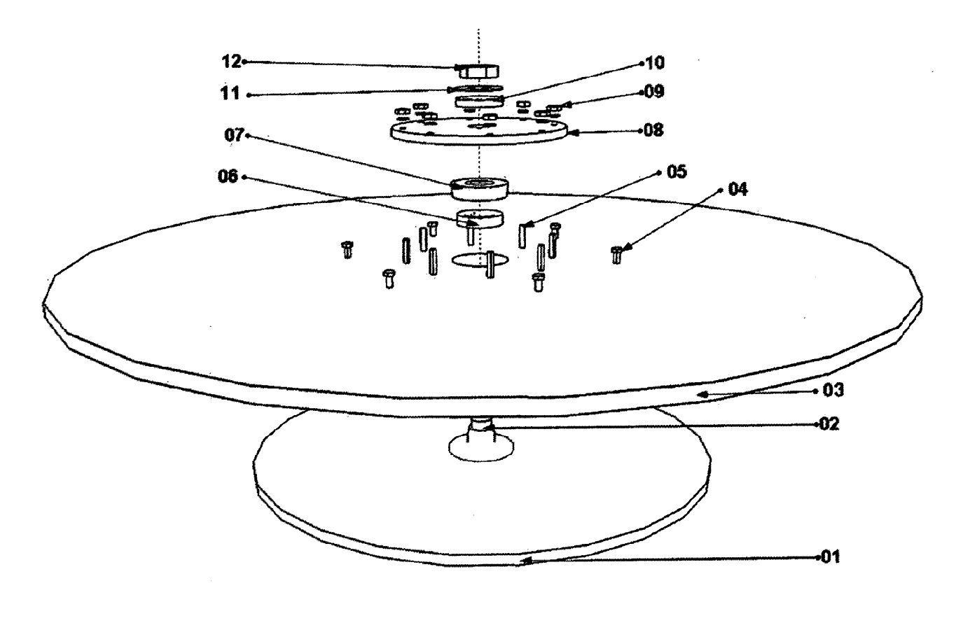

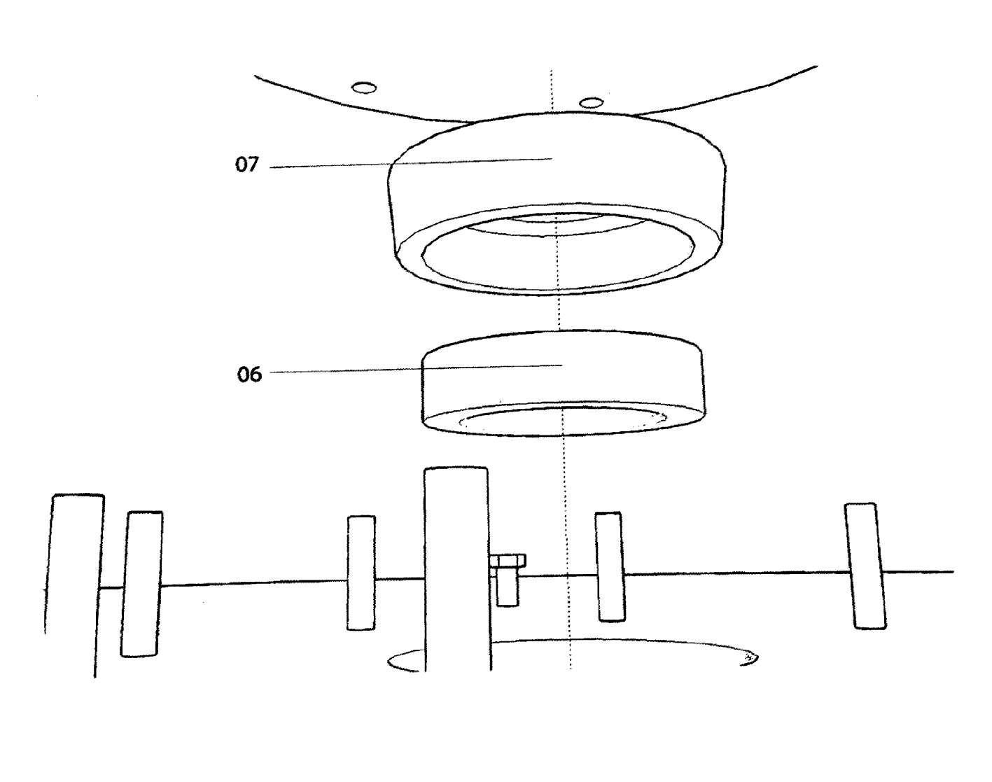

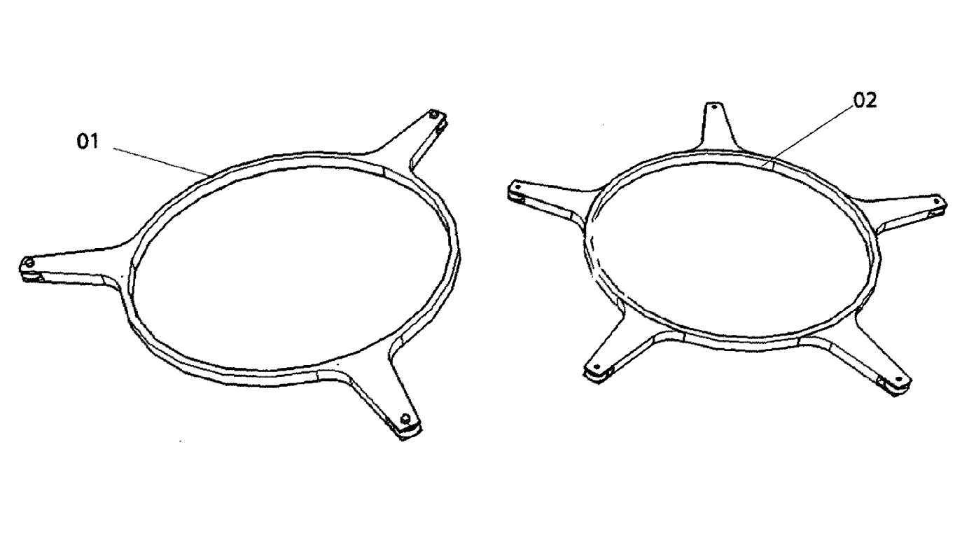

The shorter Turbine Column is able to hang off the Axis Column from the bearing within its Capping Plate, whilst the Axis Stub Axle threaded section remains protruding. FIG. 3/18—02 & FIG. 4/18—02. Therefore, to reiterate; the Thrust Bearing (which has been referred to as the Axis Bearing) is held exactly centre within a cupped recess on the underside of an externally tapered or plural shaped matching designs of steps on the exterior of the Collet. FIG. 4/18—06, 07, & FIG. 5/18—06, 07.

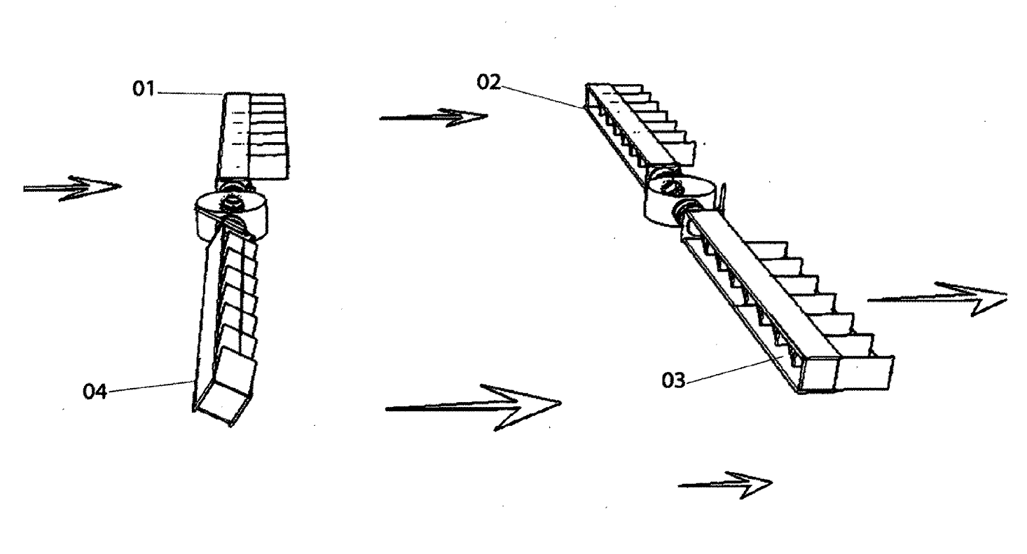

The decided Collet design holding the Axis Bearing is inserted from the top side of the Turbine Column Capping Plate into a matching tapered receptor in FIG. 3/18—03, FIG. 4/18—03, or alternative higher surface pressure designs in FIG. 11/18—1—11) once the designated Collet holding the thrust bearing is positioned, a large round Pressure Plate with a centre hole FIG. 3/18—08 & FIG. 4/18—08 is placed over the Collet with Axis Bearing intact and then bolted down to secure the Collet and Axis Bearing in a locked immovable position within the top of the Turbines Column's Capping Plate. Also Note; the pressure Plate and any of the desired Collet profiles FIG. 11/18—1—11 can be incorporated as one complete unit. A smaller Anti-Friction Bearing FIG. 4/18—10 is then inserted onto the protruding Stub Axle, a large washer FIG. 4/18—11 is then placed over it. A top Lock Nut FIG. 4/18—12 is then lightly tightened onto the Washer, and then finally turn-locked with a Split Pin (Not Featured) inserted through the end of the Stub Axle and Lock Nut. To replace Axis Bearing, several Jack Bolts inserted beyond the perimeter of a Pressure Plate FIG. 3/18—04 & FIG. 4/18—04 designed to turn through matching thread holes in the Turbine Column's Capping Plate and cranked onto the Axis Column Capping Plate FIG. 4/18—01, which will support the entire Turbine Column and enable it to be raised to the minimal requisite height for the necessary duration to change the top Axis Bearing FIG. 5/18—06. Once the Turbine Column is completely supported by the Axis Column, the loosened off Stub Axle's Lock Nut, Washer and Anti-Friction Bearing is completely removed. The pressure plate is then unbolted by removing the Nuts and Washers from Threaded Studs FIG. 4/18—05, 09 protruding through the Pressure Plate. Once the Pressure Plate is removed, the Collet and Main Bearing is extracted, and then the faulty or worn Axis Bearing is removed from within the Collet. The new Axis Bearing is then replaced in the Collet, and then reinstalled into the Turbine Columns Matching tapered Hole, the Pressure Plate is replaced, bolted down, then the anti-friction bearing, Washer and Nut are replaced and the split pin reset. Finally the Jack Bolts or Jacks are backed off, thus fully transferring the weight of the Turbine Column back onto the Axis Bearing, FIG. 4/18—06. An alternative to the Jack Bolts would be to substitute them with plural heavy-duty synchronised Hydraulic Jacks triangulated beyond the perimeter of the Pressure Plate. These would fix through special holes in the Turbine Column's Locking Plate that would press onto the Axis Column's Capping Plate. Note: The Hydraulic Jacks are not featured in any drawings as they are subject to specific weights and dimensions.

### Maintaining Steady Concentricity on Turbine Columns Lower End.

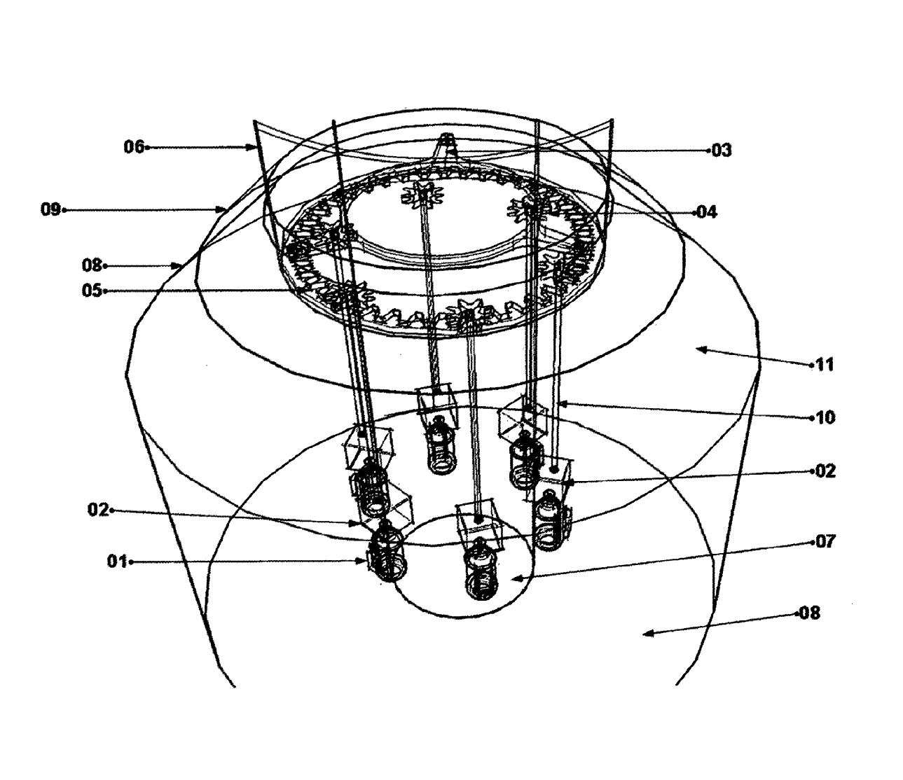

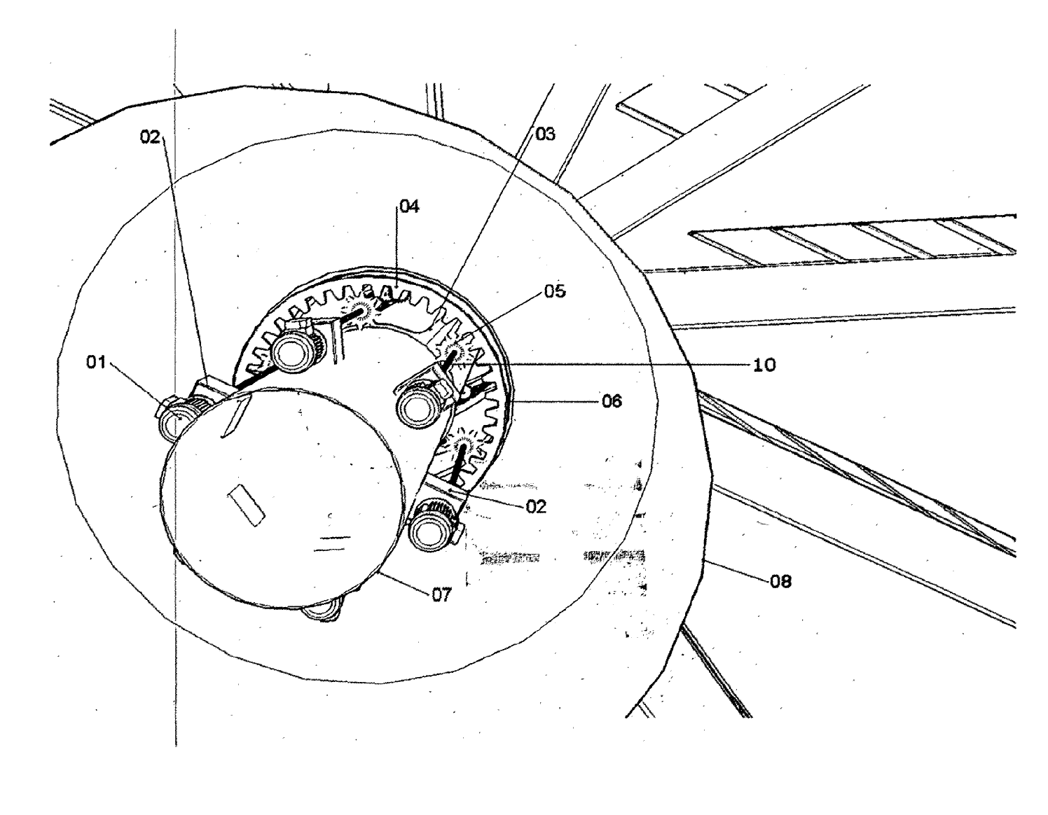

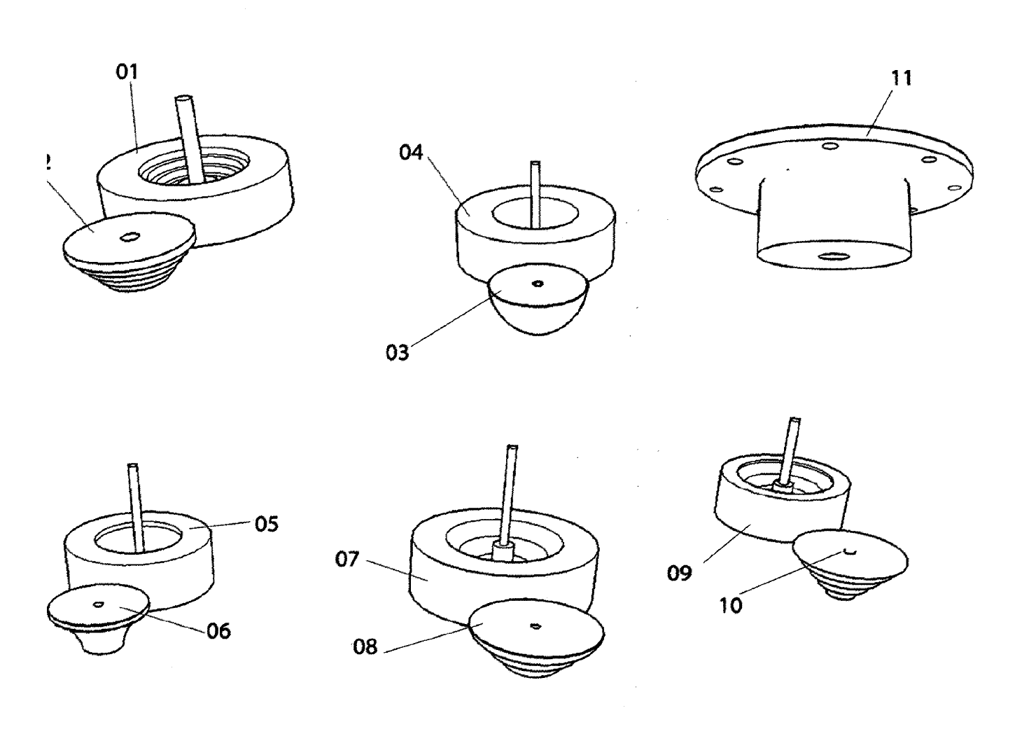

Absolute stability at the lower section of the rotating Turbine Column is essential. Therefore, whilst the Turbine Column revolves, its steadiness is sustained by plural heavy duty tapered metal arms anchored around the Axis Column at equal radial points with cam type rollers set on the projected ends of the metal arms, FIG. 6/18—01, 02, these will be called Concentric Stabilizer Arms, Essentially, these Concentric Stabilizer Arms are designed to maintain concentricity and even contact pressure within the inner wall at the lower end of the Turbine Column, see, FIG. 7/18—03. These Concentric Stabilizer Arms are fitted to make contact within a wide metal bearing track above or below the Ring Gear which is fixed near the bottom of the Turbine Column. Note the ring gear may also be bevelled at any angle, top or bottom and can also be fixed on the outside of the Turbine Column. This particular method of ensuring concentricity was designed to offset resistance or binding via friction. To be clear; fixed top and bottom retaining bearings would ultimately seize due to variations in vertical expansions or contractions between the Axis Column and the Turbine Column. Thus, the required cylindrical track must be wide enough to ensure variable highs and lows within the steel roller guides whilst being forced to follow the track and remain friction free. That is; the Concentric Stabilizer Rollers will definitely be able to float up or down quite freely. The Turbine Column will be rotated by axially arranged series of 180° Rotatable Power Booms or non Rotatable Power Booms. FIG. 1/18—01—12 & FIG. 10/18.

### Braking System

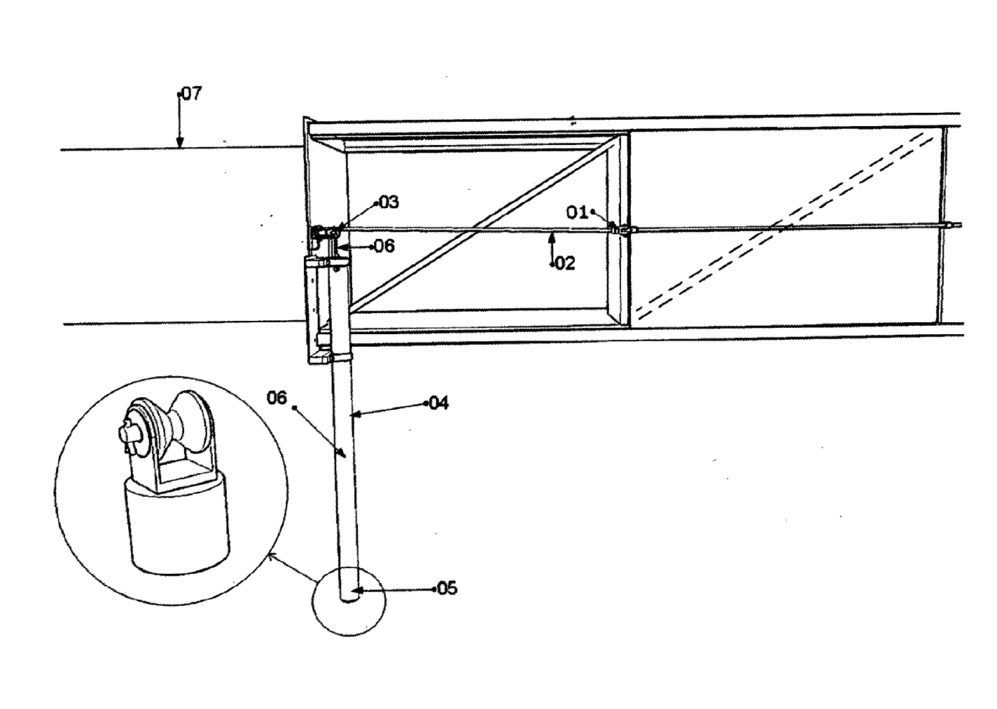

Plural Disk Brakes will be fixed at predetermined intervals on the Turbine Column's inner wall. Electrically actuated hydraulic brake callipers, (Not Featured) will be mounted on the Axis Column to interact with Brake Disks positioned within the Turbine Column. The Concentric Stabilizer Arms FIG. 8/18—03 and optional type ring gear FIG. 8/18—04 are mounted near bottom of the Turbine Column.

### Electric Generators.

At near ground level, dependent on the number of RPBs or PBs desired for power output, Plural 3-Phase Electric Generators FIG. 8/18—01 can be mounted to the fixed Axis Column FIG. 8/18—07 or on adjacent mountings anywhere below the bottom Power Booms toward ground level. These Generators will be coupled to the Turbine Column's Ring Gear FIG. 8/18—04, via smaller meshed Gears FIG. 8/18—05, Drive Shafts FIG. 8/18—10 and Gearboxes, FIG. 8/18—02. To ensure the generators are weather-proofed, they will be housed in a free standing room FIG. 7/18—08 below a flared skirt FIG. 7/18—09 attached to the Turbine Column's lower external wall.

### Design Option One

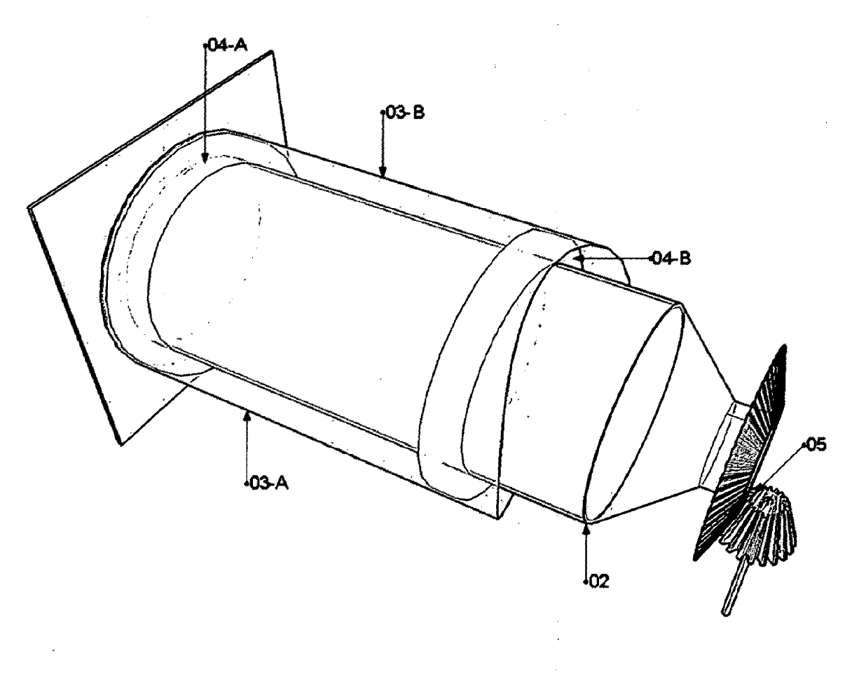

This First model Drawing 1/16, employs pairs of laterally Rotatable Power Booms, FIG. 12/18—04,

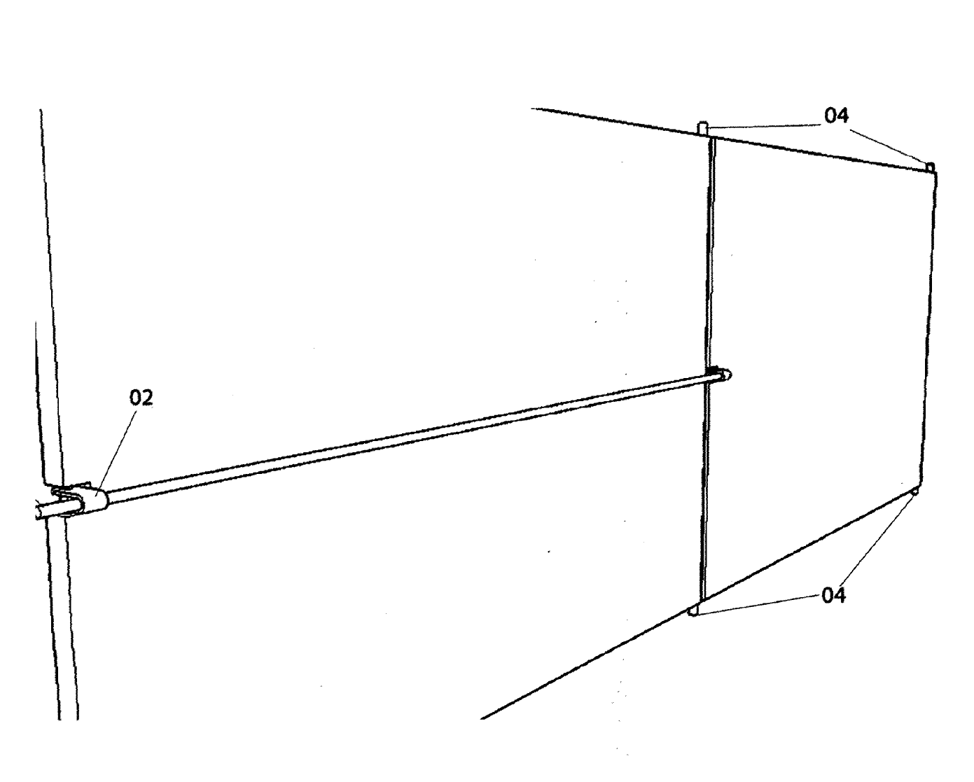

These Rotatable Power Booms will from now on be referred to as RPBs. Even numbers of RPBs are appositionally fixed in pairs at evenly stepped levels and degree indexed in a twinned spiral pattern FIG. 1/18 around the Turbine Columns external wall. Essentially, RPBs are skeletal boom structures. They have flat lateral sections top and bottom that appear to assimilate double aircraft wings, the leading edge on these flat lateral sections have a sharp wind cutting profile; that is, the edge is pointing into the wind or in a frontal attack position for streamlining FIG. 10/18—02, 04. All Vertical and Diagonal members within the RPBs have the same forward cutting profile FIG. 10/18—02—07. The trailing ends of the RPBs or PBs top and bottom lateral members should be recessed, FIG. 10/18—02 to allow the wind Vanes to be housed within the Turbine Boom frame. Upright and horizontal components structured within the boom should be flush and further away from the trailing edge to allow the inner recessed edge to be occupied by the Wind Vanes. These decisively engineered RPBs or PBs consist of straight rows of identical and equidistantly hinged Wind Vanes numbering from two upward, All Wind Vanes are hinged directly behind or aft of the upright structural members incorporated within the RPB's structure FIG. 1/18. The Vane's shape can be square or rectangular in either portrait or landscape dimensions or any feasible shape, providing they are flush faced and sequentially arranged with each hinged side fitting toward each consecutive Vanes' opening side in the closed position thus creating a linear face of doors. Crucially, every Vane's top and bottom hinge in the line must be generally vertical and co-axially hinged toward the outer arc or end of the RPB's swing, because each of the equidistantly spaced Vanes close simultaneously toward the RPB's inner arc into separate dedicated door-like frames set within the Power Boom structure. This synchronised swinging motion is accomplished via a Hinge Indexed Coupling Bar or plural Bars when the Vanes are subjected to wind forces. The Hinge Indexed Coupling Bar or Bars FIG. 15/18—03, 02 are coupled to each Vane's opening side within the lateral line of Vanes, thus enabling them to swing freely, but simultaneously whilst their compass bearing position changes in direct accordance to wind direction as the main VAWT rotates. When these Vanes are force closed due to partial or direct wind pressure on their face, a sustained pressure or energy is automatically transferred onto the rear side or trailing edge of the RPB. This pressure then levers the RPB to rotate the attached Turbine Column.

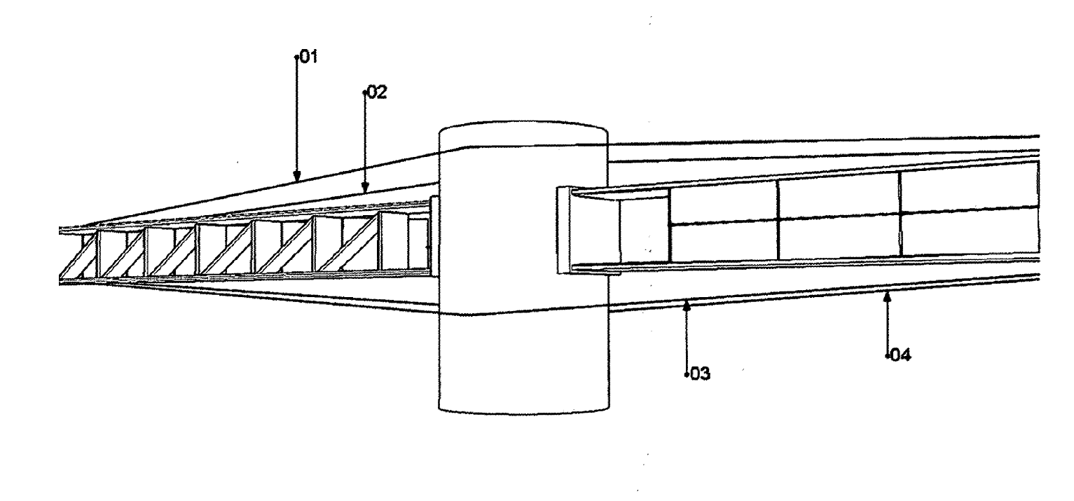

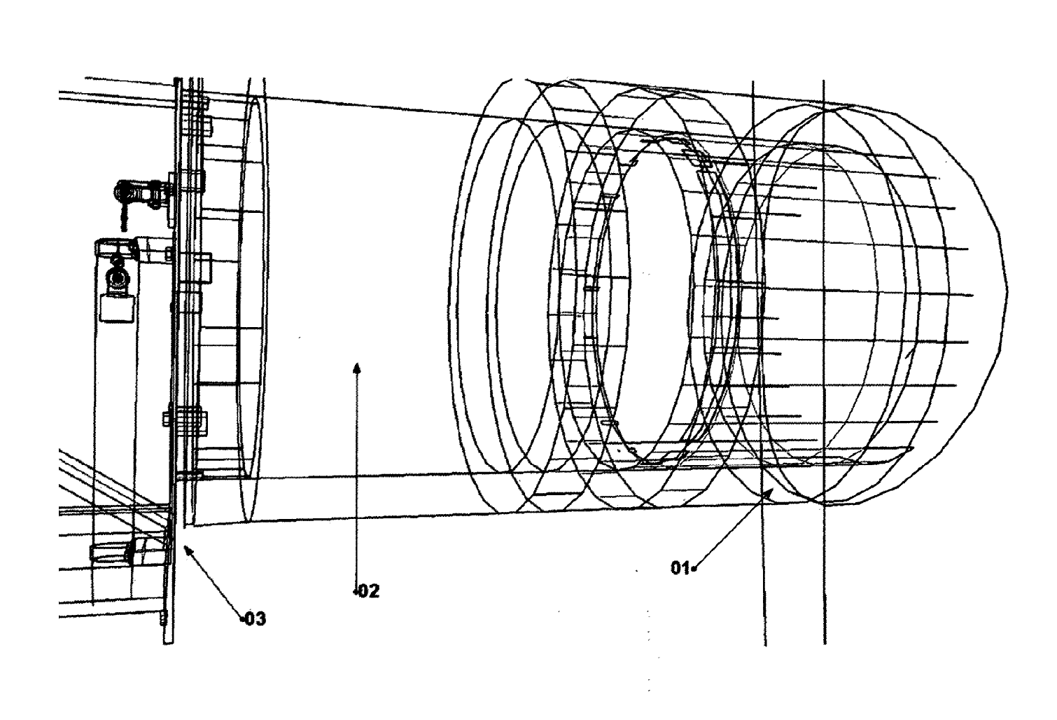

This first design, though partially explained, calls for the inner end of each RPB to be fixed to a large horizontally fitted bi-directional rotating pipe which will be known as the Horizontal Rotation Coupling Unit, which from now on shall be referred to as an HRCU. The HRCU is capable of rotating the RPB 180° in a clockwise or anti clockwise turn. The bi-directional HRCU illustrated in FIG. 17/18 indicating the interface coupling plate, FIG. 17/18—03 & FIG. 13/18—01 of the RPB and HRCU inner rotational pipe FIG. 13/18—02 welded to the coupling plate. Each HRCU's larger diameter pipe is weld mounted to an open aperture on the Turbine Column, as shown FIG. 13/18—03—B. The smaller diameter or inner rotating pipe that is welded to a coupling plate FIG. 13/18—01 with its inner end extending into the Turbine Column, FIG. 13/18-02 is laterally tumbled concentrically 180° within the larger pipe FIG. 13/18—03—A between two retaining circumference bearings FIG. 13/18—04—A & 04—B. The HRCU coupled to the RPB is set in rotation via an intermeshed bevel gear. FIG. 13/18—05 coupled to a motorised DC gearbox, which rotates the inner section of the HRCU thus adjusting the connected RPBs to a position suitable to arduous wind conditions FIG. 12/18—04 and position 12/18—03.

### Design Option Two

Design two eliminates the HRCUs. Instead, the RPBs become mere Power Booms, which will be referred to as PBs. The PB's inner ends are directly attached to the Turbine Column, FIG. 13/18. Each PB will be stayed by four Stainless Steel Cables off the Turbine Column; two Cables will be anchored at a specific height above the PB and Turbine Column's junction on opposite sides FIG. 13/18—01, 02. The opposite ends will be fixed at distance more than half-way towards the PBs' outer arc, on each side of its top member. The remaining two Stainless Steel Cable Stays will be fixed at corresponding distances under the PB as they will also be fixed onto the Turbine Column, FIG. 13/18—03, 04. The Stainless Steel Cables will be sturdy enough to withstand freak or high winds. Moreover, because these PBs are tactically stayed, they can be made considerably longer for more torque. Nonetheless, the longer designed PBs should be confined to geo-locales or areas where steady annual wind conditions have been proven favourable to their design.

Full Wind Dynamics of Power Booms under Wind Load

As already stated, wind force impacting the aligned face of multiple Vanes fitted sequentially and equidistantly with their openings set toward each consecutive hinge, and successive Vanes with coaxially set top and bottom hinges FIG. 15/18—4 positioned toward the outer end or greater arc on each RPB or PB. Note: It is imperative that the succession of Vane Hinges on the RPB or PB be positioned toward the outer arc or outer swing of the RPB or PB. The equally spaced doors must close in unison toward the inner arc of the RPB or PB into dedicated doorlike frames set in a horizontal plane. If everything addressed is in order as explained above, one half of the RPBs or PBs are automatically ready to be force turned by the wind; this means the Vanes are shut flat and the ones ensuing from behind will begin to shut in succession as the wind impacts them, even though they may be obliquely angled or right angled to wind pressure, the continuing onslaught of wind forces each Vane tightly into the Power Booms. The combined wind force on the appropriately positioned RPBs or PBs create massive pressure from the wind, and because they are fixed to the Turbine Column at its outer side, their total combined leverage, or synergised torque turns and accelerates the Turbine Column into the rotational direction it was planned to turn; that is, clockwise or anti-clockwise.

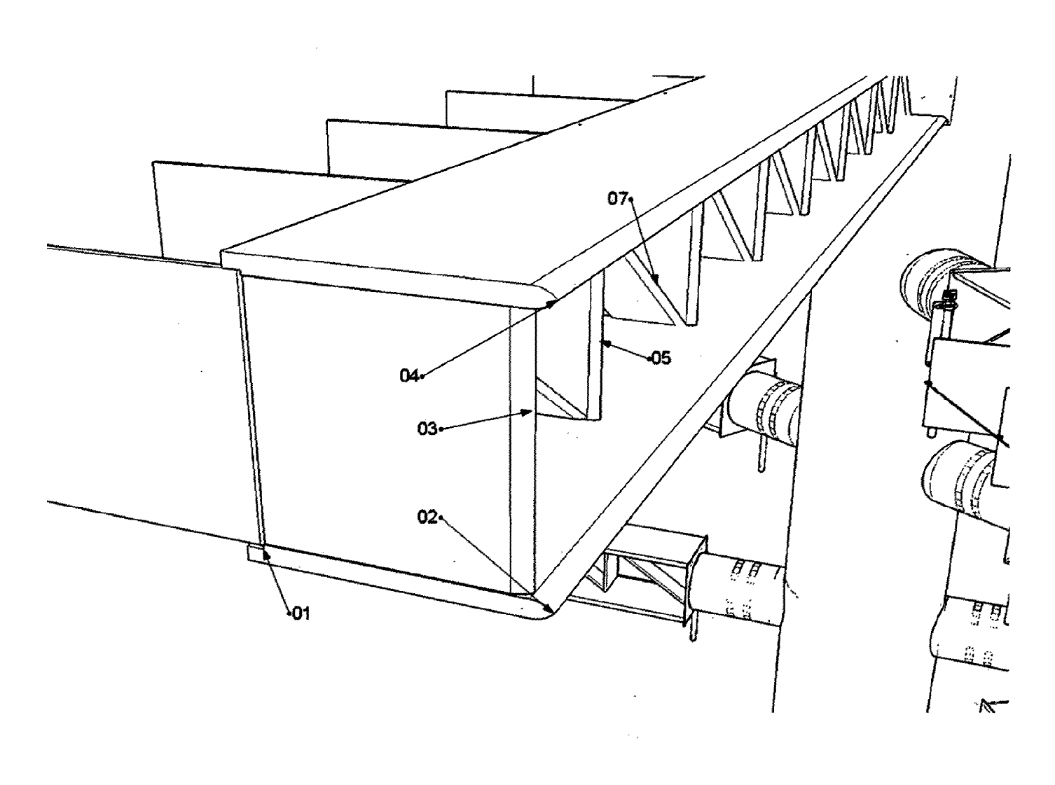

As the Turbine Column rotates, the first set of RPBs or PBs on the opposite side are forced into the opposing wind, the RPBs' or PBs Wind Vanes then swing open in tied unison via a Hinged Indexed Coupling Bar or Bars and assume an angled pitched sail position. They are immediately trimmed and held into varying pitch which is completely determined and controlled by the Vane's Snap Check and Trim System FIG. 9/18; a mechanical arrangement that employs a method of using Stainless Steel Cable FIG. 9/18—02 and a Weighted Pulley FIG. 9/18—05, plus a Centrifugal Force Weight (Not featured) that runs laterally within the Top, Bottom or Both the Lateral members of the RPBs or PBs to weight/s situated toward the end of the lateral sections for maximum force; this creates a shock absorb and vane control system. Wind speed and centrifugal force have an equal common force ratio which will be adjusted according to length and speed of the Vawt's turbine booms. Therefore, despite the opposite RPBs or PBs being fully power rotated by wind force FIG. 1/18—06, the 180° opposite RPB rotating into opposing wind force with its row of Vanes trimmed into a pitched sail position FIG. 1/18—05, means the vertically raked position will induce positive thrust in direct accord with the Turbine Column's rotation. Effectively, this positive or driving impetus reverses any would be wind drag, whilst cooperatively negating drag and adding rotational torque.

### Vane Snap Check and Trim System.

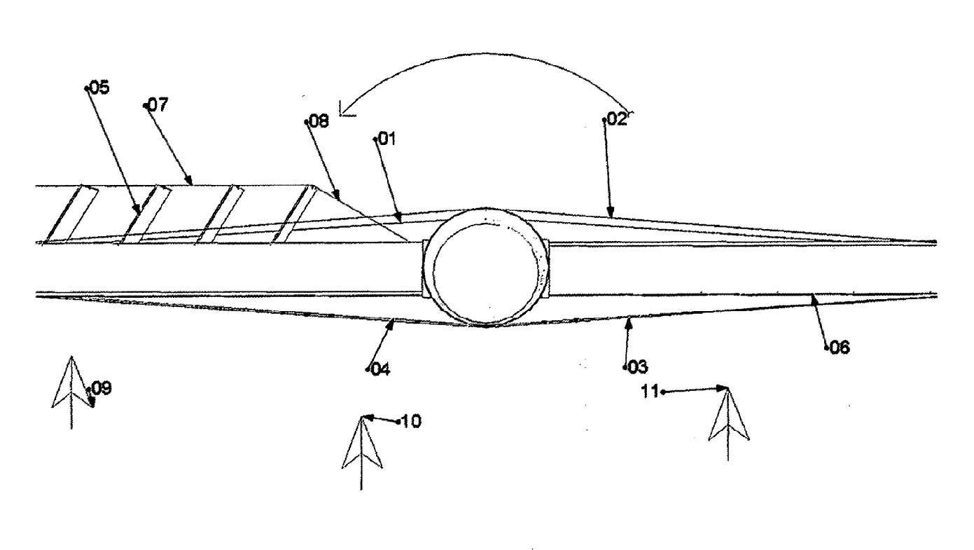

Critically, patterns of parallels between the Vane faces and rears must be maintained during all stages of opening and closing. These varying parallelogram phases are controlled via the Hinge Indexed Coupling Bar or Bars FIG. 1/18—07 which accurately hinge couple each Vane's opening edge. Vanes swinging freely and independently would result in Vanes colliding and jamming; jammed Vanes would impair the RPB or PB's performance, thus reducing the VAWT's overall efficiency. To moderate the snapping open load of Vanes and govern their angles or hold them to the most aerodynamic trim positions, the combined mechanical self adjusting system is deployed, thereby easing the powerful opening snap or shock of the Vanes' swift and spontaneous opening as wind impacts multiple sets of Vanes on their inner faces, the internal or opening side of the Vanes, are also adjusted in this manner. As each Vane is hinged directly behind an upright structural member and the RPB or PB was not controlled, the wind power would force them back 180°. The solution to this blasting open problem begins with suitable Stainless Steel Cables coupled to a swivelling connector at the inner end of the Vane coupling bar or bars, FIG. 9/18—01 from the coupling bar FIG. 9/18—02, the other end of one of the Cables is then looped around a swivel mounted Cable Pulley FIG. 9/18—03 or two Fixed Pulleys; (dependent on the VAWT's Dimensions). However, in this smaller design, only one direction changing swivel Pulley is featured and explained. After being looped over the swivel pulley the Cable turns vertically downward into an internally oil lubricated Steel Pipe, FIG. 9/18—08, the cable FIG. 9/18—04 then travels down to a heavily Weighted Pulley Wheel FIG. 9/18—05 inserted inside the pipe, the cable then U-turns around the pulley and returns upwards FIG. 9/18—01 where its end is fastened to the hanging end of a heavy duty tension spring FIG. 9/18—06 directly above the Steel Pipe. The other cable, (Not featured) is manoeuvred via internally situated Pulleys toward the leading edge or edges of the main lateral member/s of the RPB or PB. Because of gravitational force, the Weighted Pulley is able to travel vertically up and down inside the lubricated Steel Pipe. As the Vanes begin to blast open, the cable tension on the coupled Vane openings transfers the load via Cables and Pulleys to stretch the Heavy Duty Tension Spring at the top end of the Steel Pipe, until it begins to lift the Weighted Pulley in the pipe until it is stopped by an internally placed steel ring cushioned by a flexible shock absorbing concertina type washer. The Vanes via constant tension from both the weighted Pulley and Centrifugal Force from a horizontally situated weight pulling outwardly to self adjust into pitched or trim positions; see FIG. 16/18—05. This self adjusting trim is governed by the gravitational pull of pulley weight and Centrifugal Force weight as the VAWT rotates into various angles in the wind. Effectively, the variable pitch adjusting system controls are reliant on Wind force opposed to tension originating from gravitational pull from a weighted pulley and centrifugal force that is regulated or controlled by a common constant in variants of forces and the balance is dominated by Wind speed.

### Precautionary Care of the High Torque VAWT

Before erecting the VAWT, all exposed surfaces to wind and weather should be coated with a flouropolymer type paint or better. It should be of a quality that is impervious to most chemicals. Thus abrasive colliding wind borne particles are rebounded from its surface. Top and bottom Hinges on every Wind Vane should comprise of Waterproof Sealed Stainless Steel Bearings.

### Power Determination

Choice of power and consistency from the High Torque VAWT is determined directly by the number of RPBs or PBs affixed in pairs at equally divided in radial degrees. Pair levels should be equally separated by height levels on the Turbine Column.

Higher Situated RPB'S or PB's must be sequentially down-sized to accommodate faster wind speeds so as not to force rotate the lower RPBs or PBs into a negative power gain speed.

Ideally, appositionally affixed RPBs or PBs fixed at 180° in a plane on the Turbine Column can be increased sequentially. That is, the higher the number of pairs mounted in a twin spiral pattern around a Turbine Column enhances rotational consistency whilst substantially increasing the torque.

Succinctly explained, three plane levels of pairs or 6 RPBs or PBs will be offset and fixed at 60° Sixty degrees to the RPBs from levels above and or below; thus creating a twin spiral pattern.

Six planes of pairs or twelve RPBs will be indexed at 30° thirty degrees to the RPB pairs directly above and or below.
9 Pairs of RPBs or PBs totalling 18 total RPBs would be off-set at levels by 20°.
12 Pairs of RPBs or PBs n 24 total RPBs would be off-set at evels by 15°.
18 Pairs of RPBs or PBs totalling 36 totalRPBs would be off-set in levels by 10°.

### Optional Variations.

It is feasible to mount layers of three RPBs or PBs at one hundred and twenty degree angles to each other within the same plane, but it is not is not economical, vis-à-vis wind catchment. However, in the normal vane setup this configuration affects flow efficiency. Conversely however, wider spacing between the innermost Vanes and the turbine column would improve performance. Essentially, if the wider spacing of succeeding Power Booms was not affected it would create partial shielding with buffeting wind flowing onto the RPB or PB preceding it. This wind buffeting or shielding impairs RPB or PB performance in the latter part of its rotational drive position. Therefore, this tripled composition of RPBs into one plane is feasible but not ideal, as it hinders the VAWT's overall performance. Nonetheless, it could be situated where wind speeds are low and variance unusual.

### Pre-Emptive Action for RPBs in Gale Force Conditions.

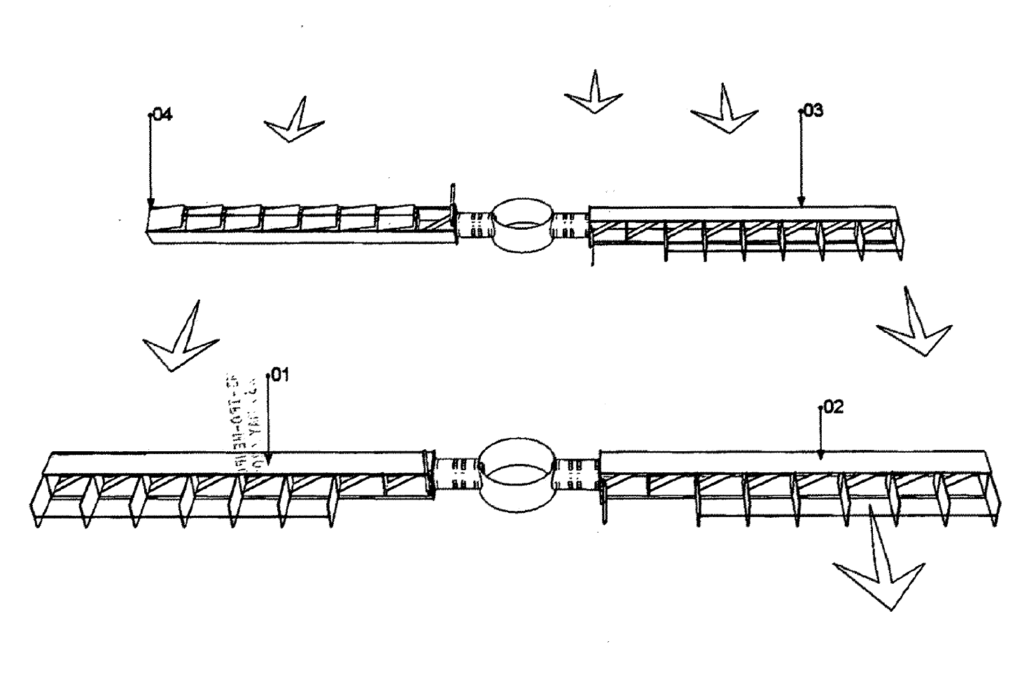

In the event of extremely high or gale force winds The Turbine Column's rotation will be stopped and locked. Computer selected RPBs FIG. 18/18—04 will then be horizontally rotated 180° clockwise or anti-clockwise to feather them FIG. 18/18—01 from damaging wind onslaught. These semi-rotations are effected via a motorised DC internal bevel gear drive system situated within the Turbine Column. The DC power supply for activating semi-rotation of the RPBs DC gear motors shall be retained within the Turbine Column. FIG. 1/18—13.

1. A Vertical Axis swinging vane wind turbine comprising of a central stationary vertical rotor support column having a single axial stub axle extending from an upper end thereof and supporting a tubular rotor about the column via a special collet of plural designs holding the thrust bearing acting between the stub axle and an upper end of the rotor which is held in situ with a lock down pressure plate or a solid unit comprising of collet design of choice and pressure plate as one, thus the main top axis bearing can be changed without dismantling the structure via alternative jacking systems between the axis columns capped top and the underside of the rotor cap, the rotor further comprising of plural radially extending wind engaging booms each supporting plural wind vanes and each vane is pivoted equidistantly on a boom so that it may swing simultaneously under wind loads between a feathered position substantially perpendicular to the length of the boom in which wind may pass the vane with a minimum of drag and a working position essentially parallel to the length of the boom wherein each of the vanes on the boom is linked to the others via a lateral indexing bar whereby the vanes are biased toward the working position by a cable, weight and a centrifugal force mechanism via a pulley arrangement such as the constantly changing angle between the vanes and the boom at any point in its rotation being controlled by a balance between the wind force and combined pull of a gravity weight and centrifugal force via the cables and pulleys, the rotatable Turbine Booms can be laterally rotated to a feathered position in hurricane force winds non rotatable booms are stayed via plural cables to the Turbine Column, higher situated power booms must be sequentially down-sized to accommodate faster wind speeds so they do not to force rotate lower power booms into a negative performance, concentricity at the lower end of the rotating Turbine Column is maintained by plural radiating equal lengths of stabilising arms fixed on the Axis Column with roller bearings subjecting equal constant pressure on the inner wall of the Turbine Column, under certain conditions alternative longer power booms of three per plane set at 120° and arranged into triple helicoids can be put into effect, an optional type ring gear capable of driving plural gear boxes coupled to matching generator is fitted at the lower end of me turbine DOOM mat win be noused wan swstcn gear equipment in a secure weather proof structure that surrounds the axis column.

2. The Vertical Axis swinging vane wind turbine of claim 1 wherein the thrust bearing is held within a specific choice of collet design with an external straight taper, angular or curved graduated steps or straight tubular collet fix fitted through the upper end of the rotor column and held in situ by a capping plate allowing the main bearing to be changed without dismantling the VAWT structure.

3. The Vertical Axis swinging vane wind turbine of claim 1 where conditions exist, the bearing collet of design choice and the pressure plate can be a complete unit.

4. The Vertical Axis swinging vane wind turbine of claim 1 further comprising hydraulic jacks or jacking bolts through upper end of the rotor and arranged so that when turned they bear against the support column to lift the rotor and relieve the rotor weight load on the bearing, thereby allowing bearing replacement.

5. The Vertical Axis swinging vane wind turbine of claim 1 in which each boom is rotatable to 180° about its radial axis so the vanes may be feathered on both sides of the turbine column to avoid damage from hurricane force winds.

6. The Vertical Axis swinging vane wind turbine of claim 1 in which each boom is stayed from the Rotor Column with four cables to the power boom that is, two to the top lateral on the boom and two to its bottom member.

7. The Vertical Axis swinging vane wind turbine of claim 1 where the swinging vanes are space linked equally via a lateral indexing bar or bars so the vanes open and close in unison.

8. The Vertical Axis swinging vane wind turbine of claim 1 whereby the combined forces of both a gravity weight and centrifugal force adjusts and controls the indexed wind vanes functional attitudes in positive response to wind force and direction.

9. The Vertical Axis swinging vane wind turbine of claim 1 wherein the various shaped collet axis bearing holders ensure easy and absolute matching within its coupling seat.

10. The Vertical Axis swinging vane wind turbine of claim 1 where under certain conditions sets of three booms radiating at 120° per plane can be fitted helicoidally around the rotor column.

11. The Vertical Axis swinging vane wind turbine of claim 1 whereby a fitted ring gear on the lower end of rotor column is able to drive plural Generators via Gearboxes.

12. The Vertical Axis swinging vane wind turbine of claim 1 explains that the gearboxes and generators coupled to the main drive gear via a coupling shaft system can be fixed anywhere on or adjacent to the axis column below the lowest set of Power Booms close to ground level.

13. The Vertical Axis swinging vane wind turbine of claim 1 clarifies that the higher situated power booms must be sequentially down-sized to accommodate faster wind speeds so as not to force rotate the lower power booms into negative performance.
